(19) United States
(12) Patent Application Publication
(10) Pub. No.: US 2025/0286622 A1
(43) Pub. Date: Sep. 11, 2025

(54) OPTICAL FIBER DISTRIBUTED WIRELESS SIGNAL COVERAGE SYSTEM BASED ON ROF TECHNOLOGY

(71) Applicant: SKYASTAR TECHNOLOGIES (ZHUHAI) LTD., ZHUHAI (CN)

(72) Inventors: MIN FU, ZHUHAI (CN); GUOPENG LUO, ZHUHAI (CN); QINGHUA LIAO, ZHUHAI (CN); JIANGUO CHEN, ZHUHAI (CN); XIAOQIN LI, ZHUHAI (CN); CHIGUANG HE, ZHUHAI (CN)

(21) Appl. No.: 19/063,935

(22) Filed: Feb. 26, 2025

Related U.S. Application Data
(63) Continuation of application No. PCT/CN2024/119676, filed on Sep. 19, 2024.

(30) Foreign Application Priority Data
Mar. 10, 2024 (CN) 202410268404.2

(51) Int. Cl. H04B 10/2575; H04B 10/50; H04L 27/04

(52) U.S. Cl. CPC H04B 10/25759; H04B 10/503; H04L 27/04

(57) ABSTRACT

Disclosed is an optical fiber distributed wireless signal coverage system based on a radio over fiber (ROF) technology, including a signal access intelligent unit, configured to perform radio frequency signal magnitude conditioning and then radio frequency amplification on a first wireless signal to obtain a first downlink electrical signal and combine the first downlink electrical signal, an OOK modulating signal, and a first radio frequency signal together and convert the same into a downlink laser signal, and output the signal to a first optical fiber interface; and further configured to convert a resultant uplink laser signal into an uplink electrical signal and perform radio frequency amplification and radio frequency signal magnitude conditioning on the uplink electrical signal to output the signal from a radio frequency interface; an optical fiber splitter, configured to divide the downlink laser signal into downlink laser sub-signals; and at least one multi-standard remote radio unit.

### TECHNICAL FIELD

The present disclosure belongs to the technical field of Radio Over Fiber (ROF) and wireless signal coverage systems and mainly relates to an ROF optical transceiver part, an optical passive part, a wireless system part, a software control part, and a software monitoring part, specifically an optical fiber distributed wireless signal coverage system based on an ROF technology.

### BACKGROUND

At present, a wireless mobile communication technology increasingly affects the modern life of people. From receiving and transmitting WeChat messages, watching short videos, microblogging, issuing TikTok videos, network payments, going out with map navigation, to watching high-definition televisions and videos at home, a mobile network of a smart phone makes people enjoy colorful life. With the increase of mobile data traffic and increasing tools and devices working in a plurality of communication platforms through channels of high bandwidth mobile communication, demand modes on Internet change. People also hope that wireless network communication supports more users and covers a wider area while hoping to enjoy high bandwidth of wireless communication, and really hope signal coverage without a signal dead angle to realize ubiquitous high-speed wireless signal coverage indeed. The increase of signal bandwidth and ever increase in the number of device users bring a huge challenge to design and architecture of a wireless signal coverage system and the operation of a future broadband wireless network. The user access bandwidth is improved and more user accesses are supported by reducing a signal coverage range of the single mobile network, constructing a small coverage area, and improving the carrier frequency and signal intensity of wireless communication.

### SUMMARY

To overcome deficiencies in the prior art, the present disclosure provides an optical fiber distributed wireless signal coverage system based on a ROF technology with low cost, high speed, and low power consumption.

The technical solution of the present disclosure is as follows:

An optical fiber distributed wireless signal coverage system based on a ROF technology is provided, including:
a signal access intelligent unit, including a radio frequency interface and a first optical fiber interface and configured to perform radio frequency signal magnitude conditioning and then radio frequency amplification on a first wireless signal received from the radio frequency interface to obtain a first downlink electrical signal and combine the first downlink electrical signal, an OOK modulating signal, and a first radio frequency signal together and convert the same into a downlink laser signal, and output the downlink laser signal to the first optical fiber interface; and further configured to convert a resultant uplink laser signal inputted from the first optical fiber interface into an uplink electrical signal and perform radio frequency amplification and radio frequency signal magnitude conditioning on the uplink electrical signal in sequence to output the uplink electrical signal from the radio frequency interface;
an optical fiber splitter, including a first optical port and at least one second optical port, where the first optical port thereof is connected to the first optical fiber interface through a first optical fiber; configured to averagely divide the downlink laser signal inputted through the first optical port into a plurality of downlink laser sub-signals, where the downlink laser sub-signals correspond to the second optical ports one by one and are outputted from the second optical ports; and further configured to combine the uplink laser signals inputted through the second optical ports into a resultant uplink laser signal and output the resultant uplink laser signal from the first optical port; and
at least one multi-standard remote radio unit, the multi-standard remote radio units including second optical fiber interfaces respectively, where the second optical fiber interfaces are respectively connected to the second optical ports of the optical fiber splitter in a one-to-one correspondence manner through a second optical fiber; configured to decompose the downlink laser sub-signals and convert the downlink laser sub-signals into second downlink electrical signals and divide the second downlink electrical signals into a first signal, a second signal, and a third signal, and perform radio frequency signal magnitude conditioning and radio frequency amplification on the third signal in sequence and transmit the third signal; and further configured to filter a received second wireless signal to obtain an uplink radio frequency signal, perform low-noise amplification and radio frequency signal magnitude conditioning on the uplink radio frequency signal in sequence and combine the uplink radio frequency signal with a second radio frequency signal and convert the same into an uplink laser signal, and transmit the uplink laser signal to the second optical fiber interfaces.

The signal access intelligent unit further includes:
a first radio frequency switch/filter, input and output ports thereof being electrically connected to a second port of the radio frequency interface;
a first downlink ATT, an input port thereof being electrically connected to the output port of the first radio frequency switch/filter;
a downlink amplifier, an input port thereof being electrically connected to an output port of the first downlink ATT;
a first signal coupler, a first input port thereof being electrically connected to an output port of the downlink amplifier;
a large dynamic ROF optical transmitter, an input port thereof being electrically connected to an output port of the first signal coupler;
an OOK modulator, an output port thereof being electrically connected to a second input port of the first signal coupler;
a wavelength division multiplexer, an input port thereof being connected to an output port of the large dynamic ROF optical transmitter through a fourth optical fiber and input and output ports thereof being connected to the first optical fiber interface through a fifth optical fiber;
a first ROF optical receiver, an input port thereof being connected to an output port of the wavelength division multiplexer through a sixth optical fiber;
a second signal coupler, an input port thereof being electrically connected to an output port of the first ROF optical receiver;
a first uplink amplifier, an Input port thereof being electrically connected to a first output port of the second signal coupler;
a first uplink ATT, an input port thereof being electrically connected to an output port of the first uplink amplifier and an output port thereof being electrically connected to the input port of the first radio frequency switch/filter;
a first communication module, an input port thereof being electrically connected to a second output port of the second signal coupler and an output port thereof being electrically connected to a third input port of the first signal coupler; and
a master monitor unit, a data port thereof being connected to a data port of the first radio frequency switch/filter, a data port of the first downlink ATT, a data port of the downlink amplifier, a data port of the large dynamic ROF optical transmitter, a data port of the OOK modulator, a data port of the first communication module, a data port of the first uplink ATT, a data port of the first uplink amplifier, and a data port of the first ROF optical receiver through a first data line.

The optical fiber splitter further includes:
a 1×N optical splitter, an input optical port thereof serving as the first optical port of the optical fiber splitter; and
at least one 1×8 optical splitter, input optical ports thereof being connected to output optical ports of the 1×N optical splitter in a one-to-one correspondence manner through the third optical fiber and output optical ports thereof serving as the second optical ports of the optical fiber splitter.

The multi-standard remote radio unit further includes:
a wavelength division demultiplexer, input and output ports thereof being connected to the second optical fiber interface through a tenth optical fiber;
a second ROF optical receiver, an input port thereof being connected to an output port of the wavelength division demultiplexer through an eighth optical fiber;
a third signal coupler, an input port thereof being electrically connected to an output port of the second ROF optical receiver;
a second downlink ATT, an input port thereof being electrically connected to a first output port of the third signal coupler;
a downlink PA, an input port thereof being electrically connected to an output port of the second downlink ATT;
a second radio frequency switch/filter, an input port thereof being electrically connected to an output port of the downlink PA;
a filter, a first port thereof being electrically connected to input and output ports of the second radio frequency switch/filter;
an antenna, electrically connected to a second port of the filter;
an uplink LNA, an input port thereof being electrically connected to the output port of the second radio frequency switch/filter;
a second uplink ATT, an input port thereof being electrically connected to an output port of the uplink LNA;
a fourth signal coupler, a first input port thereof being electrically connected to an output port of the second uplink ATT;
a variable wavelength ROF optical transmitter, an input port thereof being electrically connected to an output port of the fourth signal coupler and an output port thereof being electrically connected to the input port of the wavelength division demultiplexer through a ninth optical fiber;
an OOK demodulator, an input port thereof being electrically connected to a second output port of the third signal coupler and a data interface thereof being connected to the second downlink ATT and the downlink PA through a third data line, respectively;
a second communication module, an input port thereof being electrically connected to a third output port of the third signal coupler; and
a slave monitor unit, a data port thereof being connected to a data port of the second ROF optical receiver, a data port of the second downlink ATT, a data port of the downlink PA, a data port of the OOK demodulator, a data port of the second communication module, a data port of the uplink LNA, a data port of the second uplink ATT, and a data port of the variable wavelength ROF optical transmitter through a second data line.

The present disclosure has the beneficial effects as follows:

The system provided by the present disclosure is simple in architecture, convenient in engineering construction and engineering maintenance, and the wireless coverage system can be rapidly deployed by using an existing optical fiber network at present. The system provided by the present disclosure cannot only transmit WIFI, 4G, and 5G signals, but also transmit millimeter wave 5G signals and future 6G signals, and can perform smooth transition, thereby facilitating the update of communication systems. By adopting the large dynamic ROF optical transmission technology, the present disclosure solves a problem of optical insertion loss caused by the optical splitter and long-distance transmission. By adopting the large dynamic variable wavelength ROF optical transmission technology, the present disclosure solves a problem of laser interference of lasers of the plurality of multi-standard remote radio units 3 in an uplink optical combined path. The optical fiber distributed wireless signal coverage system based on an ROF technology provided by the present disclosure includes a signal access intelligent unit 1, an optical fiber splitter 2, and a multi-standard remote radio unit 3. The three devices are connected only with a common single model fiber, so that the cost is low and it is convenient to wire. Optical fiber connection between the signal access intelligent unit 1 and the optical fiber splitter 2 may adopt long-distance transmission of an optical fiber cable according to an actual wireless signal coverage demand. The present disclosure may support the highest 20 km transmission. Optical fiber connection between the optical fiber splitter 2 and the multi-standard remote radio unit 3 can be connection with a 200-300 m optical fiber usually according to an actual wireless signal coverage demand for signal coverage in each area indoors.

### BRIEF DESCRIPTION OF FIGURES

FIG. 1 is a system architecture diagram of the present disclosure;

FIG. 2 is a functional block diagram of a signal access intelligent unit of the present disclosure;

FIG. 3 is a functional block diagram of a multi-standard remote radio unit of the present disclosure;

FIG. 4 is a software control flowchart where a wavelength of the multi-standard remote radio unit 3 is set successfully;

FIG. 5 is a software control flowchart where a wavelength of the multi-standard remote radio unit 3 fails to set;

FIG. 6 is a system architecture diagram of a conventional digital wireless signal coverage solution;

FIG. 7 is a curve graph where third-order intercept point data is actually measured through a direct connection between a large dynamic ROF optical transmitter and an ROF optical receiver with 1 m optical fiber in the present disclosure;

FIG. 8 is a curve graph where gain data is actually measured through the direct connection between a large dynamic ROF optical transmitter and an ROF optical receiver with 1 m optical fiber in the present disclosure;

FIG. 9 is a curve graph where noise figure data is actually measured through the direct connection between a large dynamic ROF optical transmitter and an ROF optical receiver with 1 m optical fiber in the present disclosure; and

FIG. 10 is a curve graph where spurious-free dynamic range data is actually measured through a direct connection between a large dynamic ROF optical transmitter and an ROF optical receiver with 1 m optical fiber in the present disclosure.

Numerals in the drawings: 1, signal access intelligent unit; 2, optical fiber splitter; 3, multi-standard remote radio unit; 4, 1×N optical splitter; 5, 1×8 optical splitter; 8, first radio frequency switch/filter; 9, first downlink ATT; 10, downlink amplifier; 11, first signal coupler; 12, large dynamic ROF optical transmitter; 13, OOK modulator; 14, wavelength division multiplexer; 15, first power supply module; 16, first communication module; 17, master monitor unit; 18, first uplink ATT; 19, first uplink amplifier; 20, second signal coupler; 21, first ROF optical receiver; 22, wavelength division demultiplexer; 23, second ROF optical receiver; 24, third signal coupler; 25, second downlink ATT; 26, downlink PA; 27, OOK demodulator; 28, slave monitor unit; 29, second communication module; 30, second power supply module; 31, second radio frequency switch/filter; 32, filter; 33, antenna; 34, uplink LNA; 35, second uplink ATT; 36, fourth signal coupler; 37, variable wavelength ROF optical transmitter; 38, radio frequency interface; 39, first optical fiber interface; 40, second optical fiber interface; 42, first optical port; and 43, second optical port.

### DETAILED DESCRIPTION

The present disclosure is further described below through specific embodiments, and is not limited thereto.

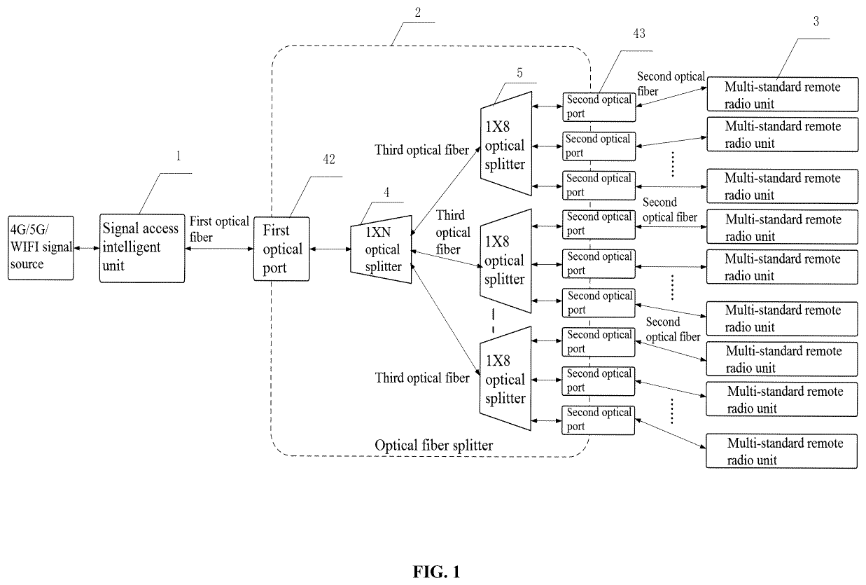

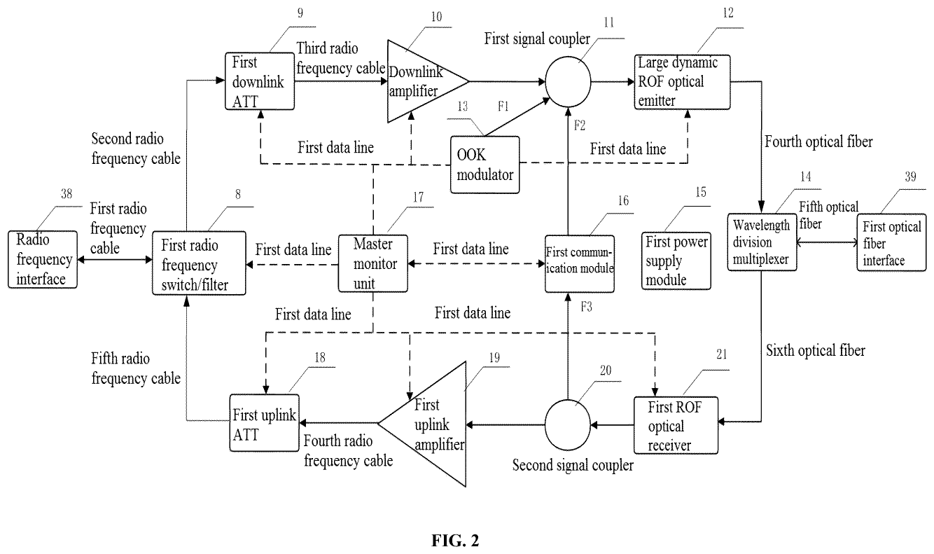

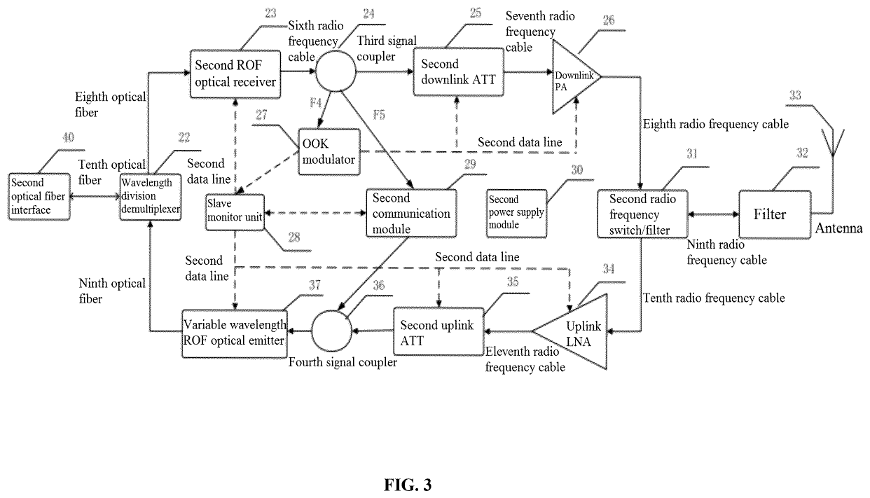

Referring to FIG. 1, FIG. 2, and FIG. 3, an optical fiber distributed wireless signal coverage system based on an ROF technology in many embodiments of the present disclosure includes a signal access intelligent unit 1, an optical fiber splitter 2, and a multi-standard remote radio unit 3.

The signal access intelligent unit 1 includes a radio frequency interface 38 and a first optical fiber interface 39. The signal access intelligent unit 1 is configured to perform radio frequency signal magnitude conditioning and then radio frequency amplification on a first wireless signal received from the radio frequency interface 38 to obtain a first downlink electrical signal and combine the first downlink electrical signal, an OOK modulating signal F1, and a first radio frequency signal F2 together and convert the same into a downlink laser signal, and output the downlink laser signal to the first optical fiber interface 39. The signal access intelligent unit 1 is further configured to convert a resultant uplink laser signal inputted from the first optical fiber interface 39 into an uplink electrical signal and perform radio frequency amplification and radio frequency signal magnitude conditioning on the uplink electrical signal in sequence to output the uplink electrical signal from the radio frequency interface 38.

The optical fiber splitter 2 includes a first optical port 42 and at least one second optical port 43, where the first optical port 42 of the optical fiber splitter 2 is connected to the first optical fiber interface 39 through a first optical fiber. The optical fiber splitter 2 is configured to averagely divide the downlink laser signal inputted through the first optical port 42 into a plurality of downlink laser sub-signals, where the downlink laser sub-signals correspond to the second optical ports 43 one by one and are outputted from the second optical ports 43. The optical fiber splitter 2 is further configured to combine the uplink laser signals inputted through the second optical ports 43 into a resultant uplink laser signal and output the resultant uplink laser signal from the first optical port 42.

In the embodiment shown in FIG. 1, there are M multi-standard remote radio units 3, M is an integer greater than or equal to 1, and the specific number is determined according to an actual demand. The multi-standard remote radio units 3 include second optical fiber interfaces 40, where the second optical fiber interfaces 40 are respectively connected to the second optical ports 43 of the optical fiber splitter 2 in a one-to-one correspondence manner through a second optical fiber. The multi-standard remote radio units 3 are configured to decompose the downlink laser sub-signals and convert the downlink laser sub-signals into second downlink electrical signals and divide the second downlink electrical signals into a first signal F4, a second signal F5, and a third signal, and perform radio frequency signal magnitude conditioning and radio frequency amplification on the third signal in sequence and transmit the third signal. The multi-standard remote radio units 3 are further configured to filter a received second wireless signal or switch the radio frequency switch to obtain an uplink radio frequency signal, perform low-noise amplification and radio frequency signal magnitude conditioning on the uplink radio frequency signal in sequence and combine the uplink radio frequency signal with a second radio frequency signal F6 and convert the same into an uplink laser signal, and transmit the uplink laser signal to the second optical fiber interfaces 40.

Referring to FIG. 2, the signal access intelligent unit 1 further includes a first radio frequency switch/filter 8, a first downlink ATT 9, a downlink amplifier 10, a first signal coupler 11, a large dynamic ROF optical transmitter 12, an OOK modulator 13, a wavelength division multiplexer 14, a first power supply module 15, a first communication module 16, a master monitor unit 17, a first uplink ATT 18, a first uplink amplifier 19, a second signal coupler 20, and a first ROF optical receiver 21.

Input and output ports of the first radio frequency switch/filter 8 are electrically connected to a second port of the radio frequency interface 38. For example, the input and output ports of the first radio frequency switch/filter 8 are electrically connected to the second port of the radio frequency interface 38 through a first radio frequency cable.

An input port of the first downlink ATT 9 is electrically connected to the output port of the first radio frequency switch/filter 8. For example, the input port of the first downlink ATT 9 is electrically connected to the output port of the first radio frequency switch/filter 8 through a second radio frequency cable.

An input port of the downlink amplifier 10 is electrically connected to an output port of the first downlink ATT 9. For example, the input port of the downlink amplifier 10 is electrically connected to the output port of the first downlink ATT 9 through a third radio frequency cable.

A first input port of the first signal coupler 11 is electrically connected to an output port of the downlink amplifier 10.

An input port of the large dynamic ROF optical transmitter 12 is electrically connected to an output port of the first signal coupler 11.

A radio frequency output port of the OOK modulator 13 is electrically connected to an input port of the first signal coupler 11.

An input port of the wavelength division multiplexer 14 is connected to an output port of the large dynamic ROF optical transmitter 12 through a fourth optical fiber and input and output ports of the wavelength division multiplexer 14 are connected to the first optical fiber interface 39 through a fifth optical fiber.

An input port of the first ROF optical receiver 21 is connected to an output port of the wavelength division multiplexer 14 through a sixth optical fiber.

An input port of the second signal coupler 20 is electrically connected to an output port of the first ROF optical receiver 21.

An Input port of the first uplink amplifier 19 is electrically connected to a first output port of the second signal coupler 20.

An input port of the first uplink ATT 18 is electrically connected to an output port of the first uplink amplifier 19. For example, the input port of the first uplink ATT 18 is electrically connected to the output port of the first uplink amplifier 19 through a fourth radio frequency cable. An output port of the first uplink ATT 18 is electrically connected to the input port of the first radio frequency switch/filter 8. For example, the output port of the first uplink ATT 18 is electrically connected to the input port of the first radio frequency switch/filter 8 through a fifth radio frequency cable.

An input port of the first communication module 16 is electrically connected to a second output port of the second signal coupler 20 and an output port of the first communication module 16 is electrically connected to a third input port of the first signal coupler 11.

A data port of the master monitor unit 17 is connected to a data port of the first radio frequency switch/filter 8, a data port of the first downlink ATT 9, a data port of the downlink amplifier 10, a data port of the large dynamic ROF optical transmitter 12, a data port of the OOK modulator 13, a data port of the first communication module 16, a data port of the first uplink ATT 18, a data port of the first uplink amplifier 19, and a data port of the first ROF optical receiver 21 through a first data line.

Referring to FIG. 1, the optical fiber splitter 2 further includes a 1×N optical splitter 4 and a 1×8 optical splitter 5.

An input optical port of the 1×N optical splitter 4 serves as the first optical port 42 of the optical fiber splitter 2.

There are a plurality of 1×8 optical splitters 5, where input optical ports of the 1×8 optical splitters 5 are connected to output optical ports of the 1×N optical splitter 4 in a one-to-one correspondence manner through the third optical fiber and output optical ports of the 1×8 optical splitters 5 serve as the second optical ports 43 of the optical fiber splitter 2.

Referring to FIG. 3, the multi-standard remote radio unit 3 further includes a wavelength division demultiplexer 22, a second ROF optical receiver 23, a third signal coupler 24, a second downlink ATT 25, a downlink PA 26, an OOK demodulator 27, a slave monitor unit 28, a second communication module 29, a second power supply module 30, a second radio frequency switch/filter 31, a filter 32, an antenna 33, an uplink LNA 34, a second uplink ATT 35, a fourth signal coupler 36, and a variable wavelength ROF optical transmitter 37.

Input and output ports of the wavelength division demultiplexer 22 are connected to the second optical fiber interface 40 through a tenth optical fiber.

An input port of the second ROF optical receiver 23 is electrically connected to an output port of the wavelength division demultiplexer 22 through an eighth optical fiber.

An input port of the third signal coupler 24 is electrically connected to an output port of the second ROF optical receiver 23. For example, the input port of the third signal coupler 24 is electrically connected to the output port of the second ROF optical receiver 23 through a sixth radio frequency cable.

An input port of the second downlink ATT 25 is electrically connected to a first output port of the third signal coupler 24.

An input port of the downlink PA 26 is electrically connected to an output port of the second downlink ATT 25. For example, the input port of the downlink PA 26 is electrically connected to the output port of the second downlink ATT 25 through a seventh radio frequency cable.

An input port of the second radio frequency switch/filter 31 is electrically connected to an output port of the downlink PA 26. For example, the input port of the second radio frequency switch/filter 31 is electrically connected to the output port of the downlink PA 26 through an eighth radio frequency cable.

A first port of the filter 32 is electrically connected to output and output ports of the second radio frequency switch/filter 31. For example, the first port of the filter 32 is electrically connected to the input and output ports of the second radio frequency switch/filter 31 through a ninth radio frequency cable.

The antenna 33 is electrically connected to a second port of the filter 32.

An input port of the uplink LNA 34 is electrically connected to the output port of the second radio frequency switch/filter 31. For example, the first port of the filter 32 is electrically connected to the input and output ports of the second radio frequency switch/filter 31 through a tenth radio frequency cable.

An input port of the second uplink ATT 35 is electrically connected to an output port of the uplink LNA 34. For example, the first port of the filter 32 is electrically connected to the input and output ports of the second radio frequency switch/filter 31 through an eleventh radio frequency cable.

A first input port of the fourth signal coupler 36 is electrically connected to an output port of the second uplink ATT 35.

An input port of the variable wavelength ROF optical transmitter 37 is electrically connected to an output port of the fourth signal coupler 36 and an output port of the variable wavelength ROF optical transmitter 37 is electrically connected to the input port of the wavelength division demultiplexer 22 through a ninth optical fiber.

An input port of the OOK demodulator 27 is electrically connected to a second output port of the third signal coupler 24.

An input port of the second communication module 29 is electrically connected to a third output port of the third signal coupler 24, and an output port of the second communication module 29 is electrically connected to the second input port of the fourth signal coupler 36.

A data port of the slave monitor unit 28 is connected to a data port of the second ROF optical receiver 23, a data port of the second downlink ATT 25, a data port of the downlink PA 26, a data port of the OOK demodulator 27, a data port of the second communication module 29, a data port of the uplink LNA 34, a data port of the second uplink ATT 35, and a data port of the variable wavelength ROF optical transmitter 37 through a second data line.

As shown in FIG. 2, FIG. 2 is a functional block diagram of the signal access intelligent unit 1. The first wireless signal such as 4G/5G/WIFI is inputted into the first radio frequency switch/filter 8 through the radio frequency interface 38, i.e., the first wireless signal such as 4G/5G/WIFI is inputted from the first port of the radio frequency interface 38, enters the input and output ports of the first radio frequency switch/filter 8 after being outputted from the second port of the radio frequency interface 38, and is transmitted and filtered by the first radio frequency switch/filter 8 to obtain a downlink signal, the downlink signal is transmitted through a second radio frequency line to the first downlink ATT 9 for radio frequency signal magnitude conditioning, and then enters the downlink amplifier 10 for radio frequency amplification to obtain a first downlink electrical signal, the first downlink electrical signal, the OOK modulating signal F1 outputted by the OOK demodulator 13, and the first radio frequency signal F2 outputted by the first communication module 16 are combined together through the first signal coupler 11 to obtain a fourth radio frequency signal, the fourth radio frequency signal is transmitted to the large dynamic ROF optical transmitter 12, the large dynamic ROF optical transmitter 12 converts the fourth radio frequency signal into a downlink laser signal, and the downlink laser signal and the resultant uplink laser signal are multiplexed in one optical fiber (the fifth optical fiber) through the wavelength division multiplexer 14, and the signal is transmitted from a long distance to the multi-standard remote radio unit 3 through the first optical fiber, the optical fiber splitter 2, and the second optical fiber in sequence from the optical fiber interface 39. The resultant uplink laser signal transmitted from the multi-standard remote radio unit 3 is decomposed by the wavelength division multiplexer 14 and transmitted to the first ROF optical receiver 21, the first ROF optical receiver 21 converts the resultant uplink laser signal into an uplink electrical signal, couples a signal F3 through the second signal coupler 20 and transmits the signal to the first communication module 16, and other uplink electrical signals are outputted to the first uplink amplifier 19 for radio frequency signal amplification, are then subjected to signal magnitude conditioning through the first uplink ATT 18, and finally, are outputted by the first radio frequency switch/filter 8 to the radio frequency interface 38 and are externally transmitted to a 4G/5G/WIFI signal source. The master monitor unit 17 in the signal access intelligent unit 1 is a central processing unit, responsible for a control command of the user and a synchronizing signal of the 4G/5G/WIFI signal source. Settings of devices in the system are controlled according to a system algorithm, parameters thereof are monitored, monitoring parameters are saved, alarms of the device are collected, and data is uploaded timely to a user monitor center. The master monitor unit 17 is further configured to modulate monitor data of the device into a first radio frequency signal F2 through the first communication module 16, modulate a synchronizing signal of the 4G/5G/WIFI signal source to an OOK modulating signal F1 through the OOK modulator 13, then modulate the first radio frequency signal F2, the OOK modulating signal F1, and the first downlink electrical signal together to the downlink laser signal for optical fiber transmission, and monitor state information of the multi-standard remote radio unit 3. The master monitor unit 17 is configured to set parameters of the multi-standard remote radio unit 3. For a downlink, the master monitor unit 17 reads the downlink output optical power from the large dynamic ROF optical transmitter 12 and compares the optical power value with a preset target optical power value. When an error is greater than a first threshold, the first downlink ATT 9 is correspondingly adjusted. The master monitor unit 17 and a monitor data packet communicated with the slave monitor unit 28 are modulated to the first radio frequency signal F2 by the first communication module 16 through the first data line and then are coupled to the large dynamic ROF optical transmitter 12 through the first signal coupler 11 to form the downlink laser signal for transmission. For an uplink, the resultant uplink laser signal is demodulated by the first communication module 16 to obtain monitor data sent by the slave monitor unit 28 and is transmitted to the master monitor unit 17 through the first data line, and the master monitor unit 17 interprets the monitor data to perform a corresponding operation. In addition, the master monitor unit 17 further needs to monitor the output power of the first uplink amplifier to determine whether the uplink output power is in a target range. If an error is greater than a second threshold, the first uplink ATT 18 is correspondingly adjusted.

The radio frequency interface 38 is configured to externally link a 4G/5G/WIFI signal source device. There are two options for the first radio frequency switch/filter 8. One is a radio frequency switch, which switches the uplink signal and the downlink signal by way of switching and is used in a TDD communication system. The other one is to separate the uplink signal from the downlink signal by using a filter and is used in an FDD communication system. The first downlink ATT 9 is configured to condition the magnitude of the first wireless signal. The downlink amplifier 10 is configured to amplify the first wireless signal subjected to signal magnitude conditioning by the first downlink ATT 9, so as to obtain the first downlink electrical signal. The first signal coupler 11 is configured to couple the signal and couple the OOK modulating signal F1 outputted by the OOK modulator 13 and the first radio frequency signal F2 outputted by the first communication module 16 into the downlink. The large dynamic ROF optical transmitter 12 is configured to convert the fourth radio frequency signal into the downlink laser signal and externally transmit the signal through the fourth optical fiber. The wavelength division multiplexer 14 is configured to perform wavelength division multiplexing on the downlink laser signal and the resultant uplink laser signal of the large dynamic ROF optical transmitter 12 into one optical fiber, i.e., the fifth optical fiber, and output the signal to the first optical fiber interface 39. The first optical fiber interface 39 is an interface connected to an external optical fiber network. The first ROF optical receiver 21 is configured to receive the resultant uplink laser signal, convert the resultant uplink laser signal into the uplink electrical signal, and output the uplink electrical signal to the second signal coupler 20. The second signal coupler 20 is configured to couple a small part of signal F3 to the first communication module 16. The first uplink amplifier 19 is configured to amplify the uplink electrical signal. The first uplink ATT 18 is configured to condition the magnitude of the uplink electrical signal amplified by the first uplink amplifier 19. The master monitor unit 17 is a processor of the signal access intelligent unit 1, is configured to control the modules, set and monitor the modules, and save monitor information. The master monitor unit 17 is configured to transmit the monitor data and modulate the monitor data signal to the first radio frequency signal F2 through the first communication module 16 and externally transmit and receive the signal. The OOK modulator 13 is configured to modulate the synchronizing signal of the TDD wireless signal to the OOK modulating signal F1 and externally transmit the signal into the first signal coupler 11. The first power supply module 15 is configured to supply power to active devices.

As shown in FIG. 1, the optical fiber splitter 2 may be a common optical fiber splitter with one optical fiber at present and has no requirements on an optical process as long as conventional technical indexes on the current market may be realized. Thus, the cost is very low, it is quite convenient to wire and construct, and a current fiber-to-the-home PON network may also be used for low cost signal coverage.

The optical fiber splitter 2 includes two-stage optical splitters, a first optical port 42, and a plurality of second ports 43. The first stage is the 1×N optical splitter 4, and the second stage is the 1×8 optical splitter 5. If the first stage 1×N optical splitter 4 is replaced with an optical fiber patch cord, the second stage uses one 1×8 optical splitter 5, thereby forming a one-in-eight network form; if the first stage 1×N optical splitter 4 uses a 1×2 optical splitter, the second stage will use two 1×8 optical splitters 5, thereby forming a one-in-sixteen network form; if the first stage 1×N optical splitter 4 uses a 1×3 optical splitter, the second stage will use three 1×8 optical splitters 5, thereby forming a one-in-twenty four network form; and by parity of reasoning, a one-in-sixty four network form may be formed at most. These optical splitters may be centralized in one place or may be separately placed in different places to facilitate construction. According to the present disclosure, one signal access intelligent unit 1 performs wireless signal coverage with 64 multi-standard remote radio units 3 through one optical fiber.

Since the optical fiber splitter 2 is reversible, besides outputting the laser, it may also input the laser. At least one uplink laser signal is inputted to the 1×8 optical splitter 5 through at least one second optical port 43 by the second optical fibers in a one-to-one correspondence manner, and together with the rest 7 uplink laser signals, are combined and transmitted to the 1×N optical splitter 4 through the third optical fiber, and then the 1×N optical splitter 4 combines the laser signals outputted by N 1×8 optical splitters 5 into one resultant uplink laser signal and outputs the resultant uplink laser signal to the first optical port 42, and transmits the resultant uplink laser signal to the signal access intelligent unit 1 through the first optical fiber. N is an integer greater than or equal to 1, and the specific number is determined according to an actual demand.

The 1×N optical splitter 4 averagely divides one beam of light into N parts by way of optically splitting one optical fiber. The first stage optical splitter is at most 8 parts, the power attenuation is 9 dB. In addition to the additional loss, the power attenuation is budged by 10 dB.

The 1×8 optical splitter 5 averagely divides one beam of light into 8 parts by way of optically splitting one optical fiber. The power attenuation is 9 dB. In addition to the additional loss, the power attenuation is budged by 10 dB.

As shown in FIG. 3, the multi-standard remote radio unit 3 decomposes the downlink laser signal transmitted by the optical fiber splitter 2 through the wavelength division demultiplexer 22 and outputs the downlink laser signal to the second ROF optical receiver 23. The second ROF optical receiver 23 converts the downlink laser signal into the second downlink electrical signal and outputs the second downlink electrical signal to the third signal coupler 24. The third signal coupler 24 divides the second downlink electrical signal into a first signal, a second signal, and a third signal. The first signal is the signal F4, which is transmitted to the OOK demodulator 27 to demodulate the synchronizing signal of the wireless signal; the second signal is the signal F5, which is transmitted to the second communication module 29, and the monitor information of the signal access intelligent unit 1 is demodulated and transmitted to the slave monitor unit 28; the third signal is the second downlink electrical signal coupled by the third signal coupler 24, is outputted to the second downlink ATT 25 for radio frequency signal magnitude conditioning, is then subjected to radio frequency signal magnitude conditioning through the downlink PA 26, is then outputted to the second radio frequency switch/filter 31, is then subjected to radio frequency filtering through the filter 32, and finally, is outputted to the antenna 33. The antenna transmits the filtered second downlink electrical signal to perform wireless signal coverage such as 4G/5G/WIFI for the covering space. The uplink radio frequency signal is extracted from the second wireless signal such as 4G/5G/WIFI signal of the user received by the antenna 33 through the filter 32 and the second radio frequency switch/filter 31. The uplink radio frequency signal is subjected to low noise amplification through the uplink LNA 34 and is then subjected to radio frequency signal conditioning through the second uplink ATT 35, the uplink radio frequency signal subjected to radio frequency signal conditioning by the second uplink ATT 35 and the second radio frequency signal F6 outputted by the second communication module 29 are coupled together through the fourth signal coupler 36 to obtain the third radio frequency signal. The third radio frequency signal is outputted to the variable wavelength ROF optical transmitter 37 for electro-optical conversion to convert the third radio frequency signal into the uplink laser signal. The uplink laser signal is multiplexed in one optical fiber, i.e., the tenth optical fiber through the wavelength division demultiplexer 22 for transmission. The slave monitor unit 28 of the multi-standard remote radio unit 3 controls parameters of the assemblies, monitors monitor information of the assemblies, and saves them in a memory. Moreover, the slave monitor unit transmits the monitored information to the signal access intelligent unit 1 through the second communication module 29 in real time. The second power supply module 30 of the multi-standard remote radio unit 3 supplies power to the active devices of the device.

The second optical fiber interface 40 is configured to be connected to an optical interface of an external optical fiber network. The wavelength division demultiplexer 22 is configured to decompose the downlink laser signal and multiplex the resultant uplink laser signal. The second ROF optical receiver 23 is configured to receive the downlink laser signal, convert the downlink laser signal into the second downlink electrical signal, and output the second downlink electrical signal to the third signal coupler 24. The third signal coupler 24 is configured to couple a small part of signals (signals F4 and F5) to the second communication module 29 and the OOK demodulator 27, respectively. The second downlink ATT 25 is configured to condition the magnitude of the third signal. The downlink PA 26 is configured to amplify the third signal. The OOK demodulator 27 is configured to demodulate the OOK signal and demodulate the synchronizing signal of the first wireless signal. The slave monitor unit 28 is a processor of the multi-standard remote radio unit 3, is configured to control the modules, set and monitor the modules, and save monitor information. The slave monitor unit may further transmit the monitor data. The second communication module 29 is configured to modulate the data signal of the slave monitor unit 28 to the second radio frequency signal F6 and externally transmit and receive the signal. In the downlink, the slave monitor unit 28 monitors the output power of the downlink PA 26 and determines whether the output power is in a target range. If an error is greater than a third threshold, the second uplink ATT 25 is adjusted. Moreover, the slave monitor unit 28 receives the monitor data demodulated by the second communication module 29 and sent by the master control unit 17, interprets the monitor data, and performs a corresponding operation. If receiving a wavelength distribution command sent by the master monitor unit 17, the slave monitor unit 28 will set the variable wavelength ROF optical transmitter 37 through the second data line, so that the variable wavelength ROF optical transmitter works at an appointed optical wavelength. In the uplink, the slave monitor unit 28 monitors the output power of the uplink LNA 34 and determines whether the output power is in a target range. If an error is greater than a fourth threshold, the slave monitor unit 28 adjusts the second uplink ATT 35 through the second data line. The second power supply module 30 is configured to supply power to active devices. There are two options for the second radio frequency switch/filter 31. One is a radio frequency switch, which switches the uplink signal and the downlink signal by way of switching and is used in a TDD communication system. The other one is to separate the uplink signal from the downlink signal by using a filter and is used in an FDD communication system. The filter 32 filters the second wireless signal and the second downlink electrical signal to filter out out-of-band spurious signals. The antenna 33 is configured to receive the second warless signal and transmit the second downlink electrical signal. The uplink LNA 34 is configured to perform low noise amplification on the uplink radio frequency signal. The second uplink ATT 35 is configured to condition the magnitude of the uplink radio frequency signal. The fourth signal coupler 36 is configured to combine the second radio frequency signal F6 outputted by the second communication module 29 and the uplink radio frequency signal together to obtain the third radio frequency signal. The variable wavelength ROF optical transmitter 37 is configured to convert the third radio frequency signal into the uplink laser signal and further has a wavelength tuning function.

An implementation of system wavelength distribution management will be described in detail below.

In the implementation of the wavelength distribution management, as shown in FIG. 1, FIG. 2, and FIG. 3, the signal access intelligent unit 1 and the multi-standard remote radio unit 3 are respectively provided with monitor units, where the monitor unit in the signal access intelligent unit 1 is the master monitor unit 17 and the monitor unit in the multi-standard remote radio unit 3 is the slave monitor unit 28. The master monitor unit 17 is responsible for managing and distributing the optical wavelength, and the slave monitor unit 28 matches with the master monitor unit 17 to deploy the optical wavelength.

A specific distribution process of the optical wavelength is as follows:

In an initial state, the master monitor unit 17 maintains a wavelength resource state, as shown in table 1.

TABLE 1
Wavelength resource state table

| Wavelength | Using state |
|---|---|
| λ₀ | System reserved as a request channel |
| λ₁ | Used |
| . . . | . . . |
| λₙ₋₁ | Unused |

In the above table, 20 is used as an initial wavelength request of the system, n is an integer greater than or equal to 1, and is the greatest 64.

In the initial state, λ₁, λ₂, . . . , λₙ₋₁ in the wavelength resource state maintained by the master monitor unit 17 all are identified as “unused” states. When the master monitor unit 17 makes a response to the wavelength distribution request and distributes the corresponding wavelength to the slave monitor unit, in this case, the master monitor unit 17 will identify the using state of the wavelength as “used”. After the wavelength resource is recycled, it will be identified as “unused”.

In the operating process, the master monitor unit 17 and the slave monitor unit 28 detect the working state of the channel. When the master monitor unit 17 detects that a certain wavelength channel works abnormally, the wavelength resource is recycled and the using state thereof is identified as “unused”. When detecting that the current wavelength channel works abnormally, the slave monitor unit 28 will initiate a wavelength distribution request flow again.

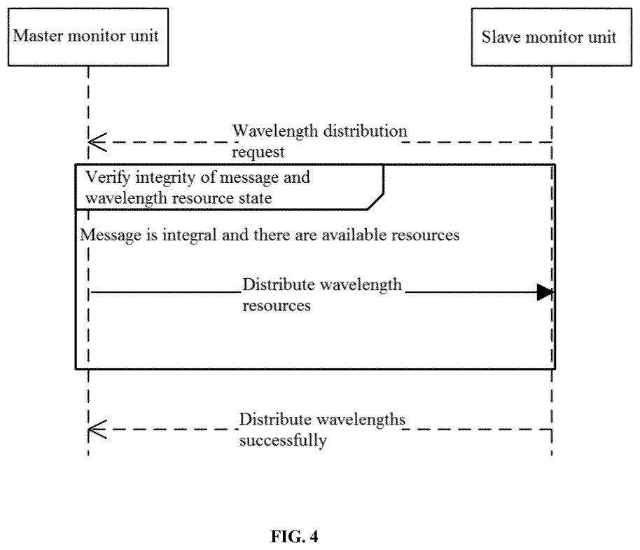

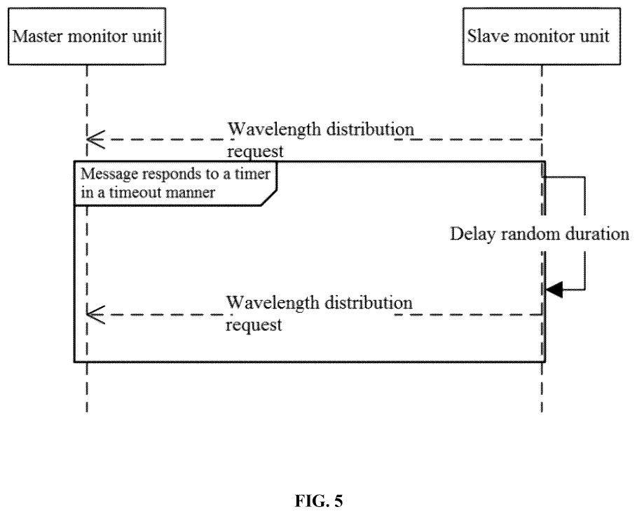

The slave monitor unit 28 in the multi-standard remote radio unit 3 powered on is in the initial state, and in this case, the working wavelength of the multi-standard remote radio unit 3 is not distributed. The multi-standard remote radio unit communicates with the master monitor unit by using the system reserved wavelength 20 to trigger the wavelength distribution request flow. A specific process is as follows:
1) the slave monitor unit 28 initiates a wavelength distribution request message at a wavelength 20 channel and starts a message response timeout timer;
2) the master monitor unit 17 receives the wavelength distribution request message and verify the integrity of the message;
(1) if the message is integral, the master monitor unit 17 distributes an unused wavelength to the slave monitor unit 28 from the optical wavelength resource table according to a certain principle;
(2) if the message is not integral, the master monitor unit 17 does not respond;
3) the slave monitor unit 28 receives a response message from the master monitor unit 17 within a fixed time of the message response timer, and if the message is integral, the slave monitor unit responds to the master monitor unit 17 with a successful message, and sets a newly distributed wavelength where the multi-standard remote radio unit 3 works in the response message, as shown in FIG. 4;
4) if the slave monitor unit 28 responds to the message timer in a timeout manner or the response message is not integral, in order to avoid conflicts with another message of the slave monitor unit 28, the slave monitor unit 28 delays random time and re-starts the wavelength distribution request flow, as shown in FIG. 5.

Compared with the prior art, the present disclosure has the following advantages and beneficial effects:

The present disclosure uses the ROF technology rather than ADC and DAC conversion, digital baseband processing, a digital optical module, and a digital HUB (router), and simulates passthrough. The working bandwidth reaches up to 10 MHz to 18 GHz. 4G, 5G, WIFI and millimeter 5G signals may be optically transmitted together to the multi-standard remote radio unit 3 for radio frequency amplification respectively to perform multi-standard signal coverage in the coverage field. According to the advantage that the working bandwidth in the ROF technology is 10 MHz to 18 GHz, the highest instant bandwidth of the wireless signal is 800 MHZ, and signal coverage of 2×2MIMO, 4×4MIMO, and millimeter 5G is realized by way of frequency shift in the system. The optical transmission optical fiber network in the present disclosure only uses a common optical splitting network with one optical fiber to realize at most 64 multi-standard remote radio units 3, as shown in FIG. 1.

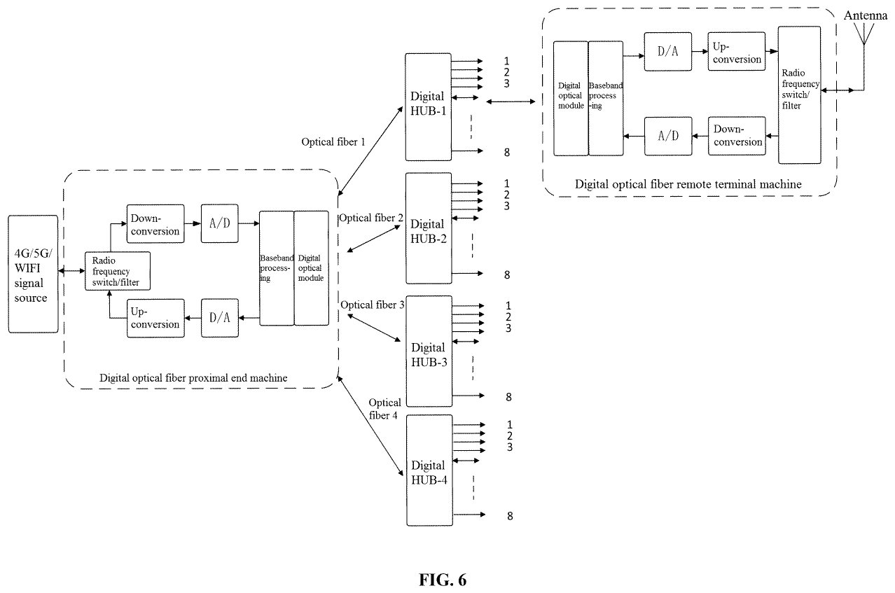

Referring to FIG. 6, the digital optical fiber proximal end machine in a conventional digital wireless signal coverage solution uses digital ADC and DAC, digital baseband processing, and the digital optical module; and the digital optical fiber remote terminal machine uses digital ADC and DAC, digital baseband processing, and the digital optical module. In order to expand the units, a digital HUB (exchanger) is used. In order to expand 32 units, 4 digital HUBs are needed at most. The whole system is complicated. To transmit 4G, 5G, WIFI, and millimeter 5G signals together, the digital transmission rate reaches up to 400 Gb/s. The material cost is very high. The system of the remote terminal is hardly miniaturized, and the power consumption is relatively high.

Through comprehensive comparison, the optical fiber distributed wireless signal coverage system based on an ROF technology is simpler than the conventional digital wireless signal coverage solution in architecture without high-speed ADC and DAC, digital baseband processing, high-speed digital optical module, high-speed HUB but transmits wireless signals such as 4G, 5G, WIFI, and millimeter 5G signals together only with the large dynamic ROF optical emission device, the ROF optical receiver, the variable wavelength ROF optical transmitter, other conventional radio frequency amplifiers, switches, filters, and the like. The system is convenient to design and construct, low in construction input, low in comprehensive cost, and suitable for large-area wireless signal coverage.

By using the large dynamic ROF optical transmission technology in the present discourse, the input P−1 of the optical link reaches up to 32 dBm, the input IP3 thereof reaches up to 50 dBm, the transmitted spurious free dynamic range (SFDR) reaches up to 123 dB/Hz^{2/3}, the transmitted optical power reaches up to 50 mW, about 17 dBm, the optical insertion (20 dB optical insertion loss caused by 64 split paths of one optical fiber and 6 dB optical insertion loss caused by a 20 km optical fiber transmitted at 1550 nm, totally 26 dB optical insertion loss) of 26 dB in the optical link is still-9 dBm in the ROF optical receiver 23, the signal is then subjected to radio frequency amplification by the subsequent amplifier, and the 5G signal meets the 3GPP requirement through actual measurement, which is the most apparent place in the technical advantages of the conventional solution.

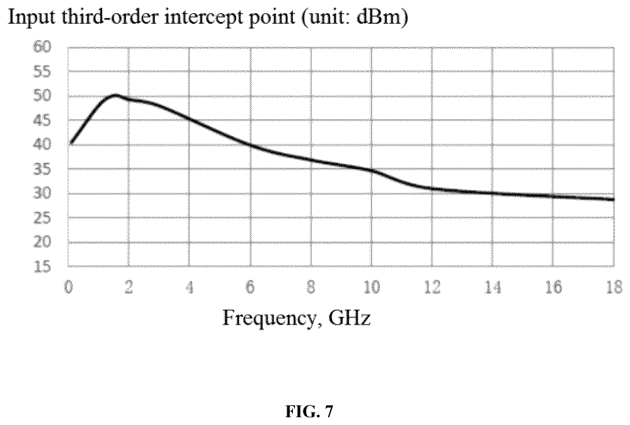

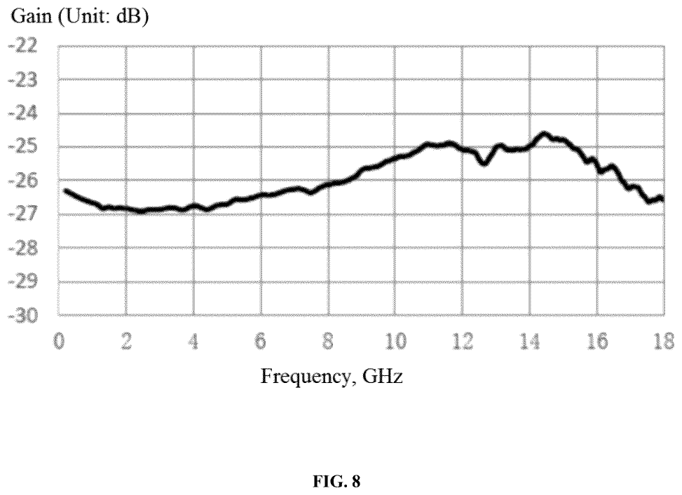

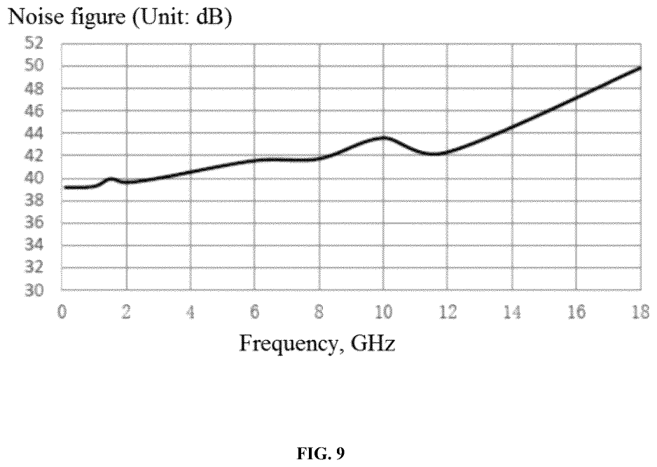

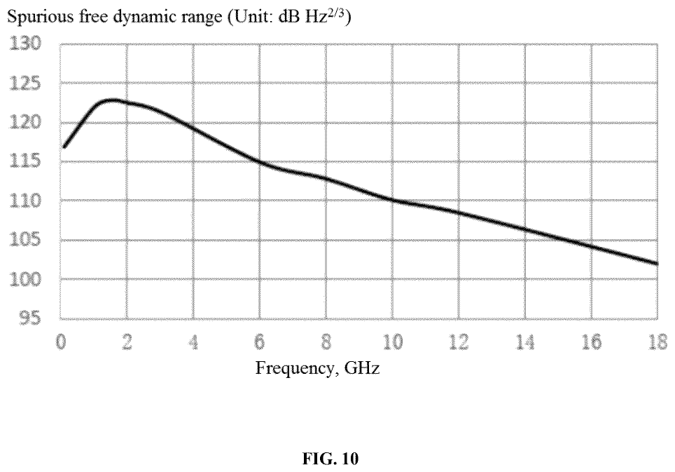

FIG. 7 is a curve graph where third-order intercept point data is actually measured through a direct connection between a large dynamic ROF optical transmitter and an ROF optical receiver with 1 m optical fiber in the present disclosure; FIG. 8 is a curve graph where gain data is actually measured through the direct connection between a large dynamic ROF optical transmitter and an ROF optical receiver with 1 m optical fiber in the present disclosure; FIG. 9 is a curve graph where noise figure data is actually measured through the direct connection between a large dynamic ROF optical transmitter and an ROF optical receiver with 1 m optical fiber in the present disclosure; and FIG. 10 is a curve graph where spurious-free dynamic range data is actually measured through a direct connection between a large dynamic ROF optical transmitter and an ROF optical receiver with 1 m optical fiber in the present disclosure.

The highest radio frequency bandwidth of the large dynamic ROF optical transmission link may reach 18 GHz.

The variable wavelength ROF optical transmission technology is used in the present disclosure. Since device terminals of at most 64 multi-standard remote radio units 3 are accessed by the optical splitting network with one optical fiber, if the 64 multi-standard remote radio units 3 use the uplink laser with the same wavelength, 64 uplink lasers form optical interference in the optical splitting network, so that the entire system cannot work normally. The signal access intelligent unit 1 in the present disclosure automatically distributes the wavelength of one uplink laser for each of the multi-standard remote radio units 3 according to the number of the multi-standard remote radio units 3, ensuring the wavelength uniqueness of each of the multi-standard remote radio units 3. Different from the wavelengths of the other multi-standard remote radio units 3, the optical interference of the 64 uplink lasers in the optical splitting network is avoided, which is the core technology of the present disclosure.

What is claimed is:

1. An optical fiber distributed wireless signal coverage system based on a radio over fiber (ROF) technology, comprising:
a signal access intelligent unit (1), comprising a radio frequency interface (38) and a first optical fiber interface (39) and configured to perform radio frequency signal magnitude conditioning and then radio frequency amplification on a first wireless signal received from the radio frequency interface (38) to obtain a first downlink electrical signal and combine the first downlink electrical signal, an OOK modulating signal (F1), and a first radio frequency signal (F2) together and convert the same into a downlink laser signal, and output the downlink laser signal to the first optical fiber interface (39); and further configured to convert a resultant uplink laser signal inputted from the first optical fiber interface (39) into an uplink electrical signal and perform radio frequency amplification and radio frequency signal magnitude conditioning on the uplink electrical signal in sequence to output the uplink electrical signal from the radio frequency interface (38);
an optical fiber splitter (2), comprising a first optical port (42) and at least one second optical port (43), wherein the first optical port (42) thereof is connected to the first optical fiber interface (39) through a first optical fiber; configured to averagely divide the downlink laser signal inputted through the first optical port (42) into a plurality of downlink laser sub-signals, wherein the downlink laser sub-signals correspond to the second optical ports (43) one by one and are outputted from the second optical ports (43); and further configured to combine the uplink laser signals inputted through the second optical ports (43) into a resultant uplink laser signal and output the resultant uplink laser signal from the first optical port (42); and
at least one multi-standard remote radio unit (3), the multi-standard remote radio units comprising second optical fiber interfaces (40) respectively, wherein the second optical fiber interfaces (40) are respectively connected to the second optical ports (43) of the optical fiber splitter (2) in a one-to-one correspondence manner through a second optical fiber; configured to decompose the downlink laser sub-signals and convert the downlink laser sub-signals into second downlink electrical signals and divide the second downlink electrical signals into a first signal (F4), a second signal (F5), and a third signal, and perform radio frequency signal magnitude conditioning and radio frequency amplification on the third signal in sequence and transmit the third signal; and further configured to filter a received second wireless signal to obtain an uplink radio frequency signal, perform low-noise amplification and radio frequency signal magnitude conditioning on the uplink radio frequency signal in sequence and combine the uplink radio frequency signal with a second radio frequency signal and convert the same into an uplink laser signal, and transmit the uplink laser signal to the second optical fiber interfaces (40).

2. The optical fiber distributed wireless signal coverage system based on a ROF technology according to claim 1, wherein the signal access intelligent unit (1) further comprises:
a first radio frequency switch/filter (8), input and output ports thereof being electrically connected to a second port of the radio frequency interface (38);
a first downlink ATT (9), an input port thereof being electrically connected to the output port of the first radio frequency switch/filter (8);
a downlink amplifier (10), an input port thereof being electrically connected to an output port of the first downlink ATT (9);
a first signal coupler (11), a first input port thereof being electrically connected to an output port of the downlink amplifier (10);
a large dynamic ROF optical transmitter (12), an input port thereof being electrically connected to an output port of the first signal coupler (11);
an OOK modulator (13), an output port thereof being electrically connected to a second input port of the first signal coupler (11);
a wavelength division multiplexer (14), an input port thereof being connected to an output port of the large dynamic ROF optical transmitter (12) through a fourth optical fiber and input and output ports thereof being connected to the first optical fiber interface (39) through a fifth optical fiber;
a first ROF optical receiver (21), an input port thereof being connected to an output port of the wavelength division multiplexer (14) through a sixth optical fiber;
a second signal coupler (20), an input port thereof being electrically connected to an output port of the first ROF optical receiver (21);
a first uplink amplifier (19), an Input port thereof being electrically connected to a first output port of the second signal coupler (20);
a first uplink ATT (18), an input port thereof being electrically connected to an output port of the first uplink amplifier (19) and an output port thereof being electrically connected to the input port of the first radio frequency switch/filter (8);
a first communication module (16), an input port thereof being electrically connected to a second output port of the second signal coupler (20) and an output port thereof being electrically connected to a third input port of the first signal coupler (11); and
a master monitor unit (17), a data port thereof being connected to a data port of the first radio frequency switch/filter (8), a data port of the first downlink ATT (9), a data port of the downlink amplifier (10), a data port of the large dynamic ROF optical transmitter (12), a data port of the OOK modulator (13), a data port of the first communication module (16), a data port of the first uplink ATT (18), a data port of the first uplink amplifier (19), and a data port of the first ROF optical receiver (21) through a first data line.

3. The optical fiber distributed wireless signal coverage system based on a ROF technology according to claim 1, wherein the optical fiber splitter (2) further comprises:
a 1×N optical splitter (4), an input optical port thereof serving as the first optical port (42) of the optical fiber splitter (2); and
at least one 1×8 optical splitter (5), input optical ports thereof being connected to output optical ports of the 1×N optical splitter (4) in a one-to-one correspondence manner through the third optical fiber and output optical ports thereof serving as the second optical ports (43) of the optical fiber splitter (2).

4. The optical fiber distributed wireless signal coverage system based on a ROF technology according to claim 1, wherein the multi-standard remote radio unit (3) further comprises:
a wavelength division demultiplexer (22), input and output ports thereof being connected to the second optical fiber interface (40) through a tenth optical fiber;
a second ROF optical receiver (23), an input port thereof being connected to an output port of the wavelength division demultiplexer (22) through an eighth optical fiber;
a third signal coupler (24), an input port thereof being electrically connected to an output port of the second ROF optical receiver (23);
a second downlink ATT (25), an input port thereof being electrically connected to a first output port of the third signal coupler (24);
a downlink PA (26), an input port thereof being electrically connected to an output port of the second downlink ATT (25);
a second radio frequency switch/filter (31), an input port thereof being electrically connected to an output port of the downlink PA (26);
a filter (32), a first port thereof being electrically connected to input and output ports of the second radio frequency switch/filter (31);
an antenna (33), electrically connected to a second port of the filter (32);
an uplink LNA (34), an input port thereof being electrically connected to the output port of the second radio frequency switch/filter (31);
a second uplink ATT (35), an input port thereof being electrically connected to an output port of the uplink LNA (34);
a fourth signal coupler (36), a first input port thereof being electrically connected to an output port of the second uplink ATT (35);
a variable wavelength ROF optical transmitter (37), an input port thereof being electrically connected to an output port of the fourth signal coupler (36) and an output port thereof being electrically connected to the input port of the wavelength division demultiplexer (22) through a ninth optical fiber;
an OOK demodulator (27), an input port thereof being electrically connected to a second output port of the third signal coupler (24) and a data interface thereof being connected to the second downlink ATT (25) and the downlink PA (26) through a third data line, respectively;
a second communication module (29), an input port thereof being electrically connected to a third output port of the third signal coupler (24); and
a slave monitor unit (28), a data port thereof being connected to a data port of the second ROF optical receiver (23), a data port of the second downlink ATT (25), a data port of the downlink PA (26), a data port of the OOK demodulator (27), a data port of the second communication module (29), a data port of the uplink LNA (34), a data port of the second uplink ATT (35), and a data port of the variable wavelength ROF optical transmitter (37) through a second data line.
